(19) United States
(12) Patent Application Publication
(10) Pub. No.: US 2007/0095114 A1
(43) Pub. Date: May 3, 2007

(54) DEVICE FOR RE-ALIGNMENT OF THE LOCK OF A SLIDING WINDOW OR DOOR FRAME

(75) Inventor: Aimone BALBO DI VINADIO, Torino (IT)

Correspondence Address: HESLIN ROTHENBERG FARLEY & MESITI PC, 5 COLUMBIA CIRCLE, ALBANY, NY, 12203, US

(73) Assignee: SAVIO S.P.A., Chiusa San Michele (Torino) (IT)

(21) Appl. No.: 11/548,491

(22) Filed: Oct. 11, 2006

(30) Foreign Application Priority Data
Oct. 31, 2005 (IT) TO2005A000772

(51) Int. Cl. E05B 13/10

(52) U.S. Cl. 70/208

(57) ABSTRACT

A cylinder lock associated to the external handle, provided for pulling, of the mobile frame of a sliding window or door frame is carried by a slider that is adjustable vertically with respect to the handle to enable correct re-alignment between the actuation pin controlled by the cylinder lock and the corresponding actuation part of the mechanism for opening the window or door frame.

### FIELD OF THE INVENTION

The present invention relates in general to sliding window and door frames which include a fixed frame and a mobile frame that can slide between an open position and a closed position.

More in particular, the invention relates to sliding window and door frames of this sort accessible from outside, for example of the so-called “French window” type that are to be located, for example, in a position corresponding to terraces or gardens.

### STATE OF THE PRIOR ART

The mobile frame of sliding window and door frames of this sort is in this case equipped with a handle for pulling, which is set on its outer side to facilitate the manoeuvres of opening and closing and to which there is normally associated, for evident reasons of security, a cylinder lock for controlling rotation of an actuation pin of the mechanism for opening the window or door frame, provided on the inner side of the mobile frame.

Typically, the mobile frame of the sliding window or door frame has a tubular upright formed, on the outer side and on the inner side, with two respective facing openings for insertion, on the outer side, of the handle bearing the cylinder lock, and, on the inner side, of a tray-like body that carries the opening mechanism, usually consisting of a catch, which can be displaced between a position of engagement and a position of disengagement of a stationary striker, set on the corresponding upright of the fixed frame of the window or door frame.

The actuation pin controlled in rotation by the cylinder lock extends horizontally through the aforesaid tubular upright of the mobile frame. In the condition of closing of the cylinder lock, the corresponding rotatable cylinder withholds the catch in engagement with the stationary striker. By turning the rotatable cylinder of the lock into the open position, the actuation pin brings about disengagement of the control catch from the stationary striker, thus enabling opening of the mobile frame of the window or door frame.

It sometimes happens that the machining operations by means of which the aforesaid two openings are formed on the tubular upright of the mobile frame are carried out at different times, or in any case in two operating steps: first the opening is formed for housing the tray with the catch on the inner surface of the tubular upright and subsequently, by turning said upright over, the opening is made on its outer face for insertion of the handle. It may thus happen that the two openings are not set perfectly aligned with respect to the vertical axis of the tubular upright, which can lead to evident problems of adjustment between the actuation pin controlled by the cylinder lock of the handle and the catch carried by the tray. This can evidently cause malfunctioning of the mechanism for opening the window or door frame.

### SUMMARY OF THE INVENTION

The purpose of the present invention is to overcome the aforesaid drawback, and more in particular to enable precise alignment between the actuation pin of the lock carried by the handle and the opening mechanism carried by the tray also in the case where there occurs, following upon fabrication of the window or door frame for the reasons clarified more fully above, a misalignment between the corresponding openings of the tubular upright of the mobile frame.

According to the invention, this purpose is achieved thanks to the fact that the cylinder lock with said actuation pin is adjustable vertically with respect to the handle.

According to a preferred embodiment of the invention, the handle has a seat, slidably mounted in which is a slider that carries the cylinder lock with the corresponding actuation pin and against which there react, on vertically opposite sides, respectively, an adjustment screw and a contrast spring.

Thanks to this arrangement, if, during fabrication of the mobile frame of the window or door frame, there occurs a misalignment between the actuation pin and the opening mechanism, as has been said, following upon a misalignment between the corresponding openings of the tubular upright of the mobile frame, simple screwing or unscrewing of the adjustment screw enables convenient re-alignment thereof, via a corresponding displacement of the slider with the cylinder lock, in a practically micrometric way.

### BRIEF DESCRIPTION OF THE DRAWINGS

The invention will now be described in detail with reference to the annexed plate of drawings, which is provided purely by of way of non-limiting example and in which:

FIG. 1 is a perspective and partially sectioned view of a part of a tubular upright of the mobile frame of a sliding window or door frame equipped with the re-alignment device according to the invention;

FIG. 2 is a side elevation of FIG. 1;

FIG. 3 is an exploded perspective view of the part of the tubular upright represented in FIGS. 1 and 2;

FIG. 4 is an exploded perspective view of the handle represented in FIGS. 1 to 3;

FIG. 5 is a perspective view of the cylinder lock carried by the handle of FIG. 4, with the corresponding actuation pin; and

FIG. 6 is a partially vertical cross-sectional view, rotated through 180°, of FIG. 5.

### DETAILED DESCRIPTION OF THE INVENTION

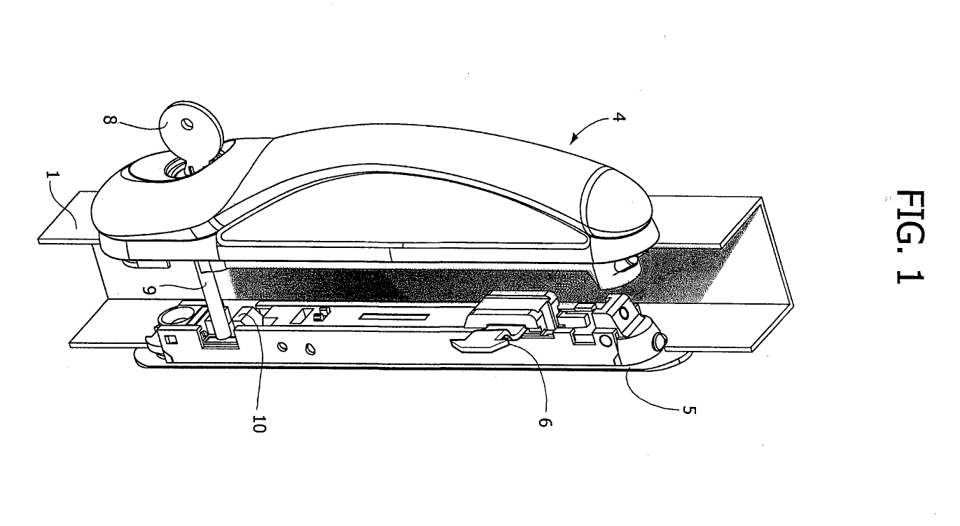

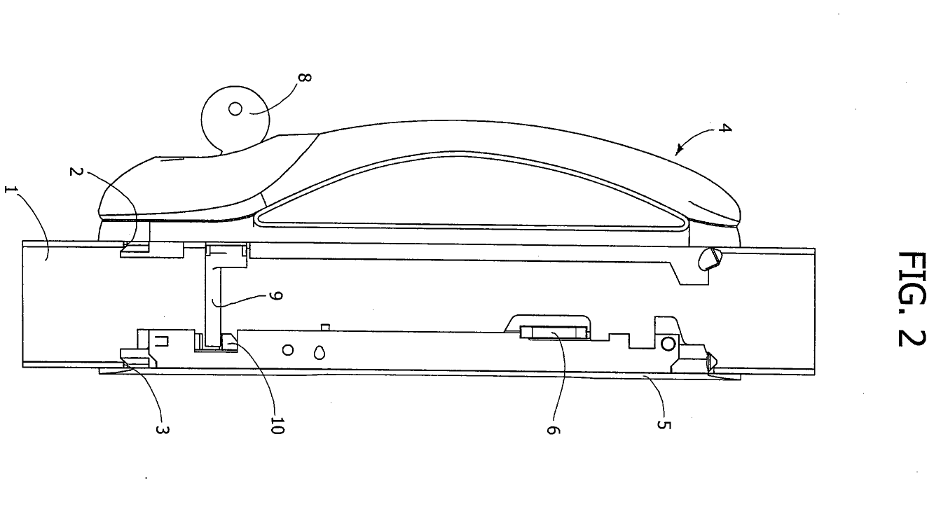

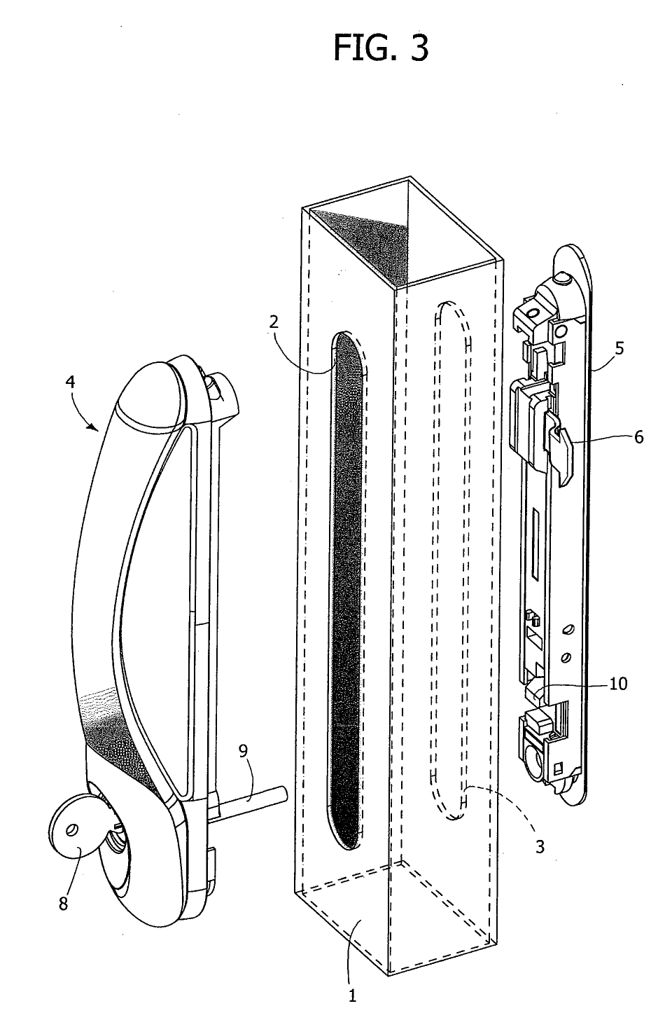

With initial reference to FIGS. 1 to 3, number 1 designates partially a tubular upright that constitutes a side of the mobile frame of a sliding window or door frame, typically a French window. The tubular upright 1 is formed, on its outer side and on its inner side, with two respective openings in the form of facing slits, designated, respectively, by 2 and 3. Inserted in the outer slit 2 is a projecting handle 4 provided for pulling from outside the mobile frame from the closed position to the open position of the window or door frame and vice versa, and housed in the inner slit 3 is a generally tray-like body 5 bearing the mechanism for opening the window or door frame. Said opening mechanism is generally in itself known, and will consequently not be described in detail herein. For the purposes of the present invention, it is sufficient to clarify that it includes a catch 6, which can be displaced manually between a raised position of engagement and a lowered position of disengagement of a stationary striker (not illustrated), carried by the fixed frame of the window or door frame. Said catch 6 may be actuated by the tray 5 via a manual control member, and by the handle 4 through a cylinder lock 7, of a generally conventional type, with rotor or rotatable cylinder and stator or fixed cylinder, and the corresponding key 8.

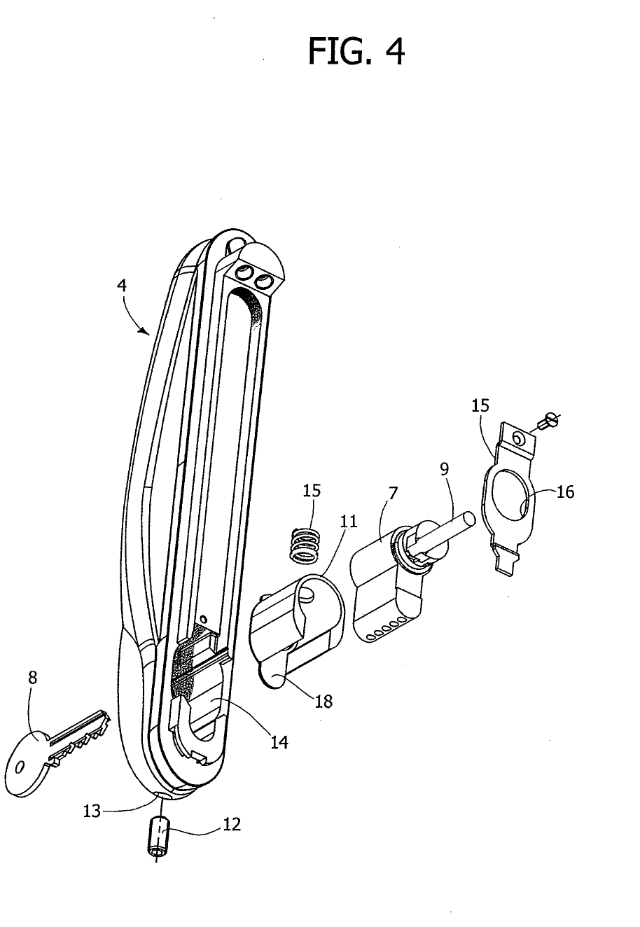

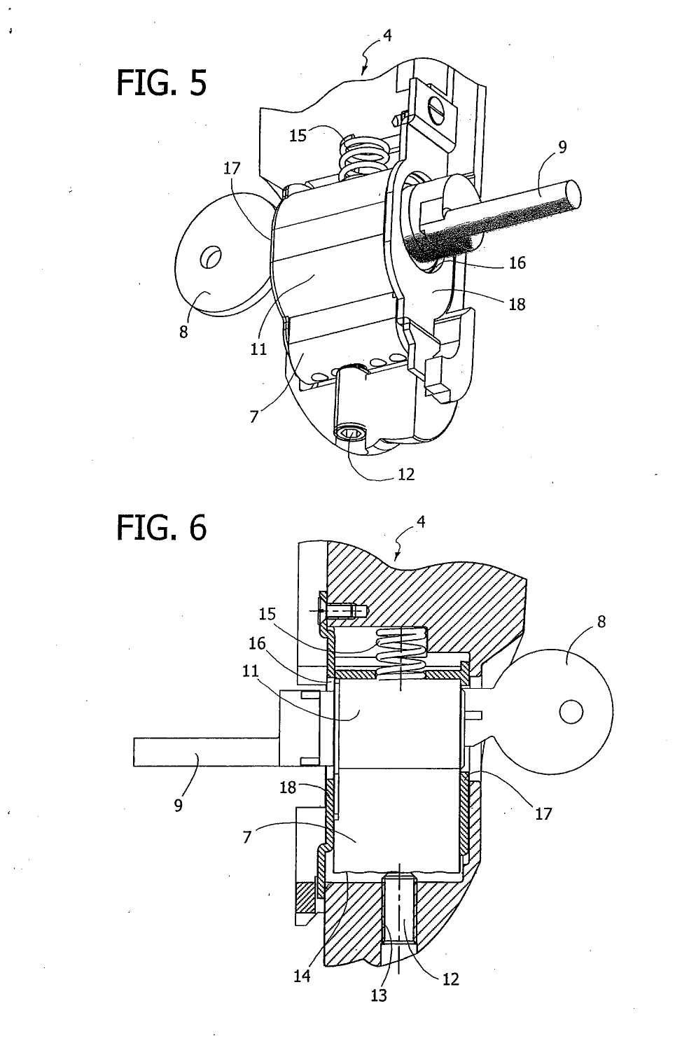

As may be seen in greater detail in FIGS. 4 to 6, the cylinder lock 7 governs in rotation, via its own rotor, an actuation pin 9, which extends horizontally through the tubular upright 1 and is inserted with its free end within an actuation part 10 which is in turn connected to the catch 6. In the condition of closing of the lock 7, the actuation pin 9, having raised the actuation part 10, withholds the catch 6 in the raised position of closing of the window or door frame. By turning the key 8 in the condition for opening the lock 7, the actuation pin 9 controls displacement downwards of the catch 6, into the position for opening the window or door frame.

It is evident that the engagement between the actuation pin 9 and the actuation part 10 calls for precise positioning of the handle 4 and of the tray 5, i.e., the correct alignment between the corresponding slits 2 and 3 of the tubular upright 1. As has been said, this can not always be obtained during the fabrication of the window or door frame on account of possible imprecision of machining for the formation of the slits 2 and 3. To solve this problem, the invention envisages a re-alignment device, by means of which it is possible, in any case, to align perfectly and in a micrometric way the actuation pin 9 with the actuation part 10.

Said re-alignment device is represented in detail in FIGS. 4 to 6. It consists of a hollow slider 11 mounted vertically so that it can slide within an internal seat 14 of the handle 4 and in which the cylinder lock 7 is mounted. A threaded grub screw 12, screwed within a corresponding threaded hole 13 formed at the base of the handle 4, reacts from beneath against the stator of the cylinder lock 7 inserted in the slider 11. On the opposite side, the slider 11 is contrasted by a helical compression spring 15.

It is evident that by screwing or unscrewing the threaded grub screw 12 it is possible to adjust the vertical position of the cylinder lock 7 with respect to the seat 14 of the handle 4, until the actuation pin 9 is positioned in the precise condition of alignment with the actuation part 10. The spring 15 enables elimination of any play between the slider 11, and hence the cylinder lock 7, and the seat 14 of the handle 4.

The seat 14 is closed, on the same side as the actuation pin 9, by a fixed plate 17 formed with an opening 16 traversed by the actuation pin 9, whilst on the opposite side the slider 11 carries a guard 18 having the function of hiding any possible gaps between the cylinder lock 7 and the front side of the handle 4, i.e., the side for introduction of the key 8, resulting from adjustment of re-alignment.

Of course, the details of construction and the embodiments may vary widely with respect to what is described and illustrated herein purely by way of example, without thereby departing from the scope of the present invention, as defined in the ensuing claims.

1. A device for re-alignment of the lock of a sliding window or door frame having a mobile frame with a tubular upright formed with two facing openings, a first opening of the openings configured for insertion of a pulling handle bearing a cylinder lock for control in rotation of an actuation pin, and a second opening of the openings configured for insertion of a mechanism for opening the window or door frame that co-operates with said actuation pin, wherein said cylinder lock with said actuation pin is adjustable vertically with respect to said handle.

2. The device according to claim 1, wherein said handle has a seat and further comprising a slider slidably mounted in said seat and bearing said cylinder lock with said actuation pin, and an adjustment screw and a contrast spring reacting against said slider on vertically opposite sides.

3. The device according to claim 2, wherein said slider carries a front guard.
